(19) United States
(12) Patent Application Publication
(10) Pub. No.: US 2008/0224086 A1
(43) Pub. Date: Sep. 18, 2008

(54) Aqueous Microcapsule Dispersions

(76) Inventors: Jurgen Falkowski, Monheim (DE); Raymond Mathis, Dusseldorf (DE); Robert Schutz, Tonisvorst (DE)

Correspondence Address: COGNIS CORPORATION;PATENT DEPARTMENT, 300 BROOKSIDE AVENUE, AMBLER, PA, 19002, US

(21) Appl. No.: 12/067,872

(22) PCT Filed: Sep. 13, 2006
(86) PCT No.: PCT/EP2006/008901

§ 371 Date: Mar. 24, 2008

(30) Foreign Application Priority Data
Sep. 22, 2005 (DE) 10 2005 045 138.1

(51) Int. Cl. B01J 13/02; B01F 17/00; D06M 23/12

(52) U.S. Cl. 252/8.91; 516/9; 264/4.1; 252/8.61

(57) ABSTRACT

An aqueous microcapsule dispersion, including water; microcapsules charged with one or more ingredients or active components; and one or more polymeric dispersants, where the polymers are homopolymers or copolymers, and the polymers comprise at least five monomer units is provided.

A method for finishing textiles, including applying, to a textile, an aqueous microcapsule dispersion comprising: water; microcapsules charged with one or more ingredients or active components; and one or more polymeric dispersants, where the polymers are homopolymers or copolymers, and the polymers comprise at least five monomer units is also provided.

### CROSS-REFERENCE TO RELATED APPLICATIONS

This application is a national phase filing under 35 U.S.C. § 371 and claims priority to International Application No. PCT/EP2006/008901 which has an International filing date of Sep. 13, 2006, and which designated the United States of America and which claims priority to German Application No. 10 2005 045138.1, filed Sep. 22, 2005, the entire disclosures of which are hereby incorporated herein by reference.

### FIELD OF THE INVENTION

This invention relates generally to aqueous microcapsule dispersions, and more particularly, to aqueous microcapsule dispersions in which the microcapsules are charged with a core material, and the one or more polymeric dispersants include homopolymers or copolymers, and methods for finishing textiles with the aqueous microcapsule dispersions.

### BACKGROUND INFORMATION

Microcapsules containing various ingredients are being increasingly used for finishing textiles. The function of the microcapsules is to delay the release of their active components on the surface of the textile in order, for example, to obtain cosmetic effects on the skin. Microcapsules with the corresponding ingredients can be produced by various methods. A summary of these methods can be found, for example, in the following literature reference: K. Lacasse, W. Baumann; Textile Chemicals, Table 6-22, Berlin 2004. The microcapsules obtained by these methods typically have a diameter of 1 to 10 μm.

In the application of microcapsules to textiles, only limited quantities of capsules can be applied because otherwise the surface properties of the textile would be excessively impaired. Accordingly, only a limited volume of active components can be applied through microcapsules.

In addition, the quantity of microcapsules on the surface of textiles can be reduced by washing so that, logically, the quantity of active components released during the wear of the textiles also decreases which is subjectively experienced as a weakening of the effect. Because of this, it is advisable to recharge the textiles with microcapsules after washing and wearing a few times.

### SUMMARY OF THE INVENTION

Briefly described, according to an aspect of the invention, an aqueous microcapsule dispersion includes: a) water; b) microcapsules charged with one or more ingredients or active components; and c) one or more polymeric dispersants, where the polymers are homopolymers or copolymers, and the polymers comprise at least five monomer units.

According to another aspect of the invention, a method for finishing textiles includes: applying, to a textile, an aqueous microcapsule dispersion including: a) water; b) microcapsules charged with one or more ingredients or active components; and c) one or more polymeric dispersants, where the polymers are homopolymers or copolymers, and the polymers comprise at least five monomer units.

### DETAILED DESCRIPTION OF THE INVENTION

The problem addressed by the present invention was to provide

microcapsules—normally produced in the form of an aqueous solution—in a supply form that would be suitable both for the original finisher and for the end consumer.

Accordingly, another problem addressed by the present invention was to provide storage-stable aqueous microcapsule dispersions. There are two key aspects to the need for storage stability:
Microcapsules generally contain organic ingredients of which the density is lower then the density of the water in the continuous phase of the dispersion. This means that the capsules in the dispersion tend to accumulate at the surface and also to agglomerate there. The further processing of the capsules is thus made very difficult. Accordingly, it is important both in the initial finishing of the textiles in industrial processes and during recharging by the end user to apply the microcapsules from a stable and monomerically divided dispersion.
According to studies by applicants, the choice of suitable additives capable of effecting the dispersion of microcapsules b) is not trivial. If, for example, typical surfactant-containing dispersants, such as products of the addition of alkylene oxides onto alcohols, for example fatty alcohol ethoxylates, are used, the polymer shell of the microcapsules b) is damaged or softened. This can even result in leakage of the ingredients from the capsules during storage.

It has now surprisingly been found that storage-stable aqueous microcapsules dispersions can be produced by using certain dispersants c).

The present invention relates to aqueous microcapsule dispersions containing
a) water,
b) microcapsules charged with one or more ingredients or active components and
c) polymeric dispersants in which the polymers can be homopolymers or copolymers and can be made up of at least five monomer units.

The dispersions according to the invention solve the problems stated above in excellent fashion. In particular, it should be emphasized that
the dispersions are stable in storage for long periods;
the polymeric shell of the microcapsules is not damaged or softened by the compounds c);
the take-up of the microcapsules by textiles is not impaired by the compounds c), nor are any deposits left on the rollers after application of the microcapsules to the textiles;
the dispersions can be used both in industrial processes (absorption, padding) and at the end user (recharging of textiles, for example after washing).

In one embodiment, viscosity adjusters d) are added to the microcapsule dispersions according to the invention, the compounds d) having to be chemically different from the compounds c).

Accordingly, the present invention also relates to microcapsule dispersions containing
a) water,
b) microcapsules charged with one or more ingredients or active components,
c) polymeric dispersants in which the polymers can be homopolymers or copolymers and can be made up of at least five monomer units and
d) viscosity adjusters,
   with the proviso that the compounds d) have to chemically different from the compounds c).

If desired, the microcapsule dispersions according to the invention may also contain other additives typically used in the finishing of textiles.

### Microcapsules b)

In the context of the present invention, microcapsules are basically understood to be organic polymers with a certain three-dimensional structure (cf.: K. Lacasse and W. Baumann, Textile Chemicals, Environmental Data and Facts, Berlin 2004, pages 468-482). So far as their three-dimensional structure is concerned, the microcapsules are hollow microspheres which typically have a diameter of 2 to 2,000 μm and an external diameter of 0.1 to 200 μm and, more particularly, 0.5 to 150 μm. Because they are hollow, the microcapsules can be charged with ingredients or active components.

Charged microcapsules, i.e., microcapsules charged with one or more ingredients or active components, are always used for the purposes of the present invention. In principle, the ingredients or active components may be any substances which are intended to be passed onto the skin during the wearing of the textile finished with the charged microcapsules (through contacting of the textile with the microcapsule dispersions according to the invention). Such substances include, for example, fats, oils, plant extracts, vitamins, perfumes, repellents, insecticides and the like. Preferred oils are vegetable oils with skin-care and health-promoting properties, for example coconut oil, passion flower oil, shea butter, rose hip seed oil, lavender oil, apricot kernel oil. Preferred plant extracts are rhodysterol and aloe vera. Of particular importance for the purposes of the invention are active components or ingredients which have skin-care, moisturizing, stimulating, soothing, cellulitis-reducing, skin-firming, repellent and refreshing properties.

The encapsulated substances—hereinafter also referred to as the core material—may consist of any solid, liquid or gaseous materials which are to be incorporated in corresponding products in encapsulated form. Perfumes, such as perfume oils, or substances with a care effect in the intended field of application are preferably used as the core materials.

Individual perfume compounds may be used as perfume oils or perfumes and include, for example, synthetic products of the ester, ether, aldehyde, ketone, alcohol and hydrocarbon type. Examples of perfume compounds of the ester type are benzyl acetate, phenoxyethyl isobutyrate, p-tert.butyl cyclohexylacetate, linalyl acetate, dimethyl benzyl carbinyl acetate, phenyl ethyl acetate, linalyl benzoate, benzyl formate, ethylmethyl phenyl glycinate, allyl cyclohexyl propionate, styrallyl propionate and benzyl salicylate. Ethers include, for example, benzyl ethyl ether while aldehydes include, for example, the linear alkanals containing 8 to 18 carbon atoms, citral (geranial), citronellal, citronellyloxyacetaldehyde, cyclamen aldehyde, hydroxycitronellal, lilial and bourgeonal. Examples of suitable ketones are the ionones, α-isomethylionone and methyl cedryl ketone. Suitable alcohols are anethol, citronellol, eugenol, isoeugenol, geraniol, linalool, phenylethyl alcohol and terpineol. The hydrocarbons mainly include the terpenes, such as limonene and α-pinene. Eucalyptol (1,8-cineol) may also be used as a perfume. However, it is preferred to use mixtures of different perfume compounds which, together, produce an agreeable fragrance. Such perfume oils may also contain natural perfume mixtures which are obtainable from vegetable sources, for example pine, citrus, jasmine, patchouli, rose or ylang-ylang oil. Other suitable perfume oils are sage oil, camomile oil, clove oil, melissa oil, mint oil, eucalyptus oil, cinnamon leaf oil, lime-blossom oil, juniper berry oil, vetiver oil, olibanum oil, galbanum oil and ladanum oil and orange blossom oil, neroli oil, orange peel oil and sandalwood oil. Other suitable perfumes are nitriles, sulfides, oximes, acetals, ketals, acids, Schiff's bases, heterocyclic nitrogen compounds, such as indole and quinoline, pyrazines, amines, such as anthanilates, amides, organohalogen compounds, such as rose acetate, nitrated compounds, such as nitromusk, heterocyclic sulfur compounds, such as thiazoles, and heterocyclic oxygen compounds, such as epoxides, which are all known to the expert as possible perfumes.

Examples of care components are vitamins and provitamins, such as vitamin A, vitamin C, vitamin E (α-tocopherol), vitamin F (polyene fatty acids), panthenol (provitamin B5), β-carotene (provitamin A) and derivatives thereof (for example esters, such as stearyl ascorbate), plant extracts, biopolymers, antidandruff agents, UV protection factors, emollients (cosmetic oils), silicone oils.

For cosmetic applications, preferred care components are tocopherols and lipid-soluble derivatives thereof. Suitable tocopherols are for example, the natural tocopherols and mixtures thereof and synthetic tocopherols. Suitable derivatives are, for example, tocopheryl acetate, tocopherol nicotinate, tocopheryl ascorbate, tocopheryl retinoate, tocopheryl succinate, tocopheryl linoleate or tocopheryl benzoate.

### Compounds c)

As already mentioned, the compounds c) are polymeric dispersants, i.e., compounds which, structurally, may be regarded as polymers and which have a dispersing and/or emulsifying effect on the microcapsules b). The polymers c) may be homopolymers or copolymers and must consist of at least five monomer units.

In a preferred embodiment, homopolymers are used as the compounds c).

In another preferred embodiment, polymers c) with molecular weights of at least 500 are used as the compounds c).

The monomer units on which the polymeric dispersants c) are based may originate from natural raw material sources or may be of synthetic origin. Examples of polymeric dispersants c) of which the monomer units are of natural origin are polymers based on cellulose (for example, sodium carboxymethyl cellulose) or polysaccharides (for example, xanthan gum, gellan gum, guar or pectins). Examples of polymeric dispersants c) of which the monomer units are of synthetic origin are acrylates (for example, sodium polyacrylates), methacrylates or alkyl acrylates (for example, pemulen).

If desired, the monomer units of which the dispersants c) are made up may also be chemically modified.

In a most particularly preferred embodiment, compounds selected from the group consisting of xanthan gum, gellan gum, guar, polyacrylates are used as the polymeric dispersants c). These dispersants may be used individually or in admixture with one another.

### Viscosity Adjusters d)

The viscosity adjusters d) may be, for example, organic or inorganic salts. For example, alkali metal salts or alkaline earth metal salts, for example sodium chloride or magnesium chloride, may be used. Suitable organic salts are, for example, urea, urea derivatives or amino acids. In addition, surface-active compounds such as, for example, alkali metal soaps of long-chain carboxylic acids, alkali metal salts of sulfonic acids, alkali metal salts of alcohol sulfates or alcohol ether sulfates, for example sodium cumenesulfonate, sodium lauryl sulfate or sodium lauryl ether sulfate, may also be used.

### Microcapsule Dispersions

The microcapsule dispersions according to the invention preferably have a capsule concentration of 1 to 50% by weight. The concentration of microcapsules is preferably in the range from 1 to 20% by weight. The percentages by weight mentioned represent % by weight of microcapsules, based on the dispersion as a whole.

The microcapsules may have a diameter of 0.1 to 200 μm, the preferred range being 1 to 20 μm.

The microcapsules charged with one or more active components and/or ingredients may be produced by any of the methods known to the relevant expert. A summary of corresponding methods can be found, for example, in the following literature reference: K. Lacasse, W. Baumann; Textile Chemicals, Table 6-22, Berlin 2004.

Basically, there are no particular limits to the quantity in which the polymeric dispersants c) to be used in accordance with the invention are present in the aqueous microcapsule dispersions. However, the polymeric dispersants c) are preferably used in quantities of 0.05 to 2% by weight and more particularly in quantities of 0.1 to 1% by weight. The percentages by weight mentioned represent % by weight of dispersants c), based on the dispersion as a whole.

The polymeric dispersants c) may be directly introduced into an aqueous dispersion of the microcapsules b) and dissolved therein, the temperature optionally being slightly elevated, preferably to a value in the range from 20 to 80° C. The use of dispersing machines, for example toothed dispersing machines or high-pressure homogenizers, may be desirable, but is not generally necessary. It is preferably avoided in order to prevent unwanted damage to the microcapsules before or during application to the textile which could even result in unwanted premature release of the active components present.

The present invention also relates to the use of the aqueous microcapsule dispersions mentioned for finishing textiles of any kind with microcapsules.

The present invention also relates to a process for finishing textiles with microcapsules in which the textiles are contacted with the aqueous microcapsule dispersions mentioned above.

### EXAMPLES

### Substances Used

Cosmedia Guar: cationized guar (Cognis)
Keltrol F: xanthan gum (Kelco)
Cosmedia SP: polyacrylate (Cognis)

### Example 1

955 grams of an aqueous microcapsule dispersion containing 40% by weight of about 2-5 μm microcapsules with oil-containing care ingredients tended to separate on account of the density of the oils (including coconut oil) present, i.e., the capsules settled at the surface as agglomerates. The dispersion was heated to 60° C. and 2.5 grams of Cosmedia Guar and 2.5 grams of Keltrol F were added in portions as polymeric dispersants, followed by intensive stirring until the polymeric dispersants had completely dissolved. 40 grams of magnesium chloride hexahydrate were then added for viscosity adjustment. The product was then cooled with stirring to 20° C. The microcapsule dispersion thus produced had a viscosity of 1280 mPas (Brookfield, 250° C., spindle 31, 50 r.p.m.). After storage for 6 months, no separation was observed. The viscosity had remained substantially constant at 1350 mPas.

### Example 2

998 grams of an aqueous microcapsule dispersion containing 40% by weight of about 2-5 μm microcapsules with mosquito-repellent ingredients were stirred into 668 grams of deionized water. In view of the density of the organic constituents (including N,N-diethyl-m-toluamide) present in the microcapsules, the dispersion tended to separate, i.e., the capsules floated. The dispersion was heated to 60° C. and 2.0 grams of Cosmedia SP were added as polymeric dispersant, followed by intensive stirring until the dispersant had completely dissolved. After cooling, the microcapsule dispersion thus produced had a viscosity of 23 mPas (Brookfield, 25° C., spindle 21, 100 r.p.m.). After storage for 6 months, no separation was observed. The viscosity was unchanged and the dispersion remained homogeneous.

### Example 3

994 grams of an aqueous microcapsule dispersion containing 40% by weight of about 2-5 μm microcapsules with anti-cellulitis ingredients were stirred into 894 grams of deionized water. In view of the density of the organic constituents (including shea butter, apricot kernel oil and rose hip oil) present in the microcapsules, the capsule dispersion tended to separate, i.e., the capsules floated. The capsule dispersion was heated to 60° C. and 6.0 grams of Cosmedia SP were added in portions, followed by intensive stirring until the dispersant had completely dissolved. After cooling, the microcapsule dispersion thus produced had a viscosity of 420 mPas (Brookfield, 25° C., spindle 31, 50 r.p.m.). After storage for 6 months, the dispersion had a viscosity of 450 mPas. The dispersion remained homogeneous.

What is claimed is:

1-7. (canceled)

8. An aqueous microcapsule dispersion, comprising:
a) water;
b) microcapsules charged with one or more ingredients or active components; and
c) one or more polymeric dispersants, wherein the polymers are homopolymers or copolymers, and wherein the polymers comprise at least five monomer units.

9. The aqueous microcapsule dispersion according to claim 8, further comprising: d) one or more viscosity adjusters, with the proviso that the one or more viscosity adjusters are different from the one or more polymeric dispersants.

10. The aqueous microcapsule dispersion according to claim 8, wherein homopolymers are used as the one or more polymeric dispersants.

11. The aqueous microcapsule dispersion according to claim 8, wherein copolymers are used as the one or more polymeric dispersants.

12. The aqueous microcapsule dispersion according to claim 8, wherein the one or more polymeric dispersants are selected from the group consisting of xanthan gum, gellan gum, guar, polyacrylates, and mixtures thereof.

13. The aqueous microcapsule dispersion according to claim 9, wherein homopolymers are used as the one or more polymeric dispersants.

14. The aqueous microcapsule dispersion according to claim 9, wherein copolymers are used as the one or more polymeric dispersants.

15. The aqueous microcapsule dispersion according to claim 9, wherein the one or more polymeric dispersants are selected from the group consisting of xanthan gum, gellan gum, guar, polyacrylates, and mixtures thereof.

16. The aqueous microcapsule dispersion according to claim 10, wherein the one or more polymeric dispersants are selected from the group consisting of xanthan gum, gellan gum, guar, polyacrylates, and mixtures thereof.

17. The aqueous microcapsule dispersion according to claim 11, wherein the one or more polymeric dispersants are selected from the group consisting of xanthan gum, gellan gum, guar, polyacrylates, and mixtures thereof.

18. The aqueous microcapsule dispersion according to claim 13, wherein the one or more polymeric dispersants are selected from the group consisting of xanthan gum, gellan gum, guar, polyacrylates, and mixtures thereof.

19. The aqueous microcapsule dispersion according to claim 14, wherein the one or more polymeric dispersants are selected from the group consisting of xanthan gum, gellan gum, guar, polyacrylates, and mixtures thereof.

20. A method for finishing textiles, comprising
applying, to a textile, an aqueous microcapsule dispersion comprising:
a) water;
b) microcapsules charged with one or more ingredients or active components; and
c) one or more polymeric dispersants, wherein the polymers are homopolymers or copolymers, and wherein the polymers comprise at least five monomer units.

21. The method according to claim 20, wherein the aqueous microcapsule dispersion further comprises: d) one or more viscosity adjusters, with the proviso that the one or more viscosity adjusters are different from the polymeric dispersants.

22. The method according to claim 20, wherein homopolymers are used as the one or more polymeric dispersants.

23. The method according to claim 20, wherein copolymers are used as the one or more polymeric dispersants.

24. The method according to claim 20, wherein the one or more polymeric dispersants are selected from the group consisting of xanthan gum, gellan gum, guar, polyacrylates, and mixtures thereof.

25. The method according to claim 21, wherein homopolymers are used as the one or more polymeric dispersants.

26. The method according to claim 21, wherein copolymers are used as the one or more polymeric dispersants.

27. The method according to claim 21, wherein the one or more polymeric dispersants are selected from the group consisting of xanthan gum, gellan gum, guar, polyacrylates, and mixtures thereof.
